(19) United States
(12) Patent Application Publication
(10) Pub. No.: US 2014/0340062 A1
(43) Pub. Date: Nov. 20, 2014

(54) SINGLE-STAGE SOLAR-PHOTOVOLTAIC POWER CONVERSION CIRCUITRY

(71) Applicant: NavSemi Energy Private Limited, Singapore (SG)

(72) Inventors: Babu Jain, Cupertino, CA (US); Vijayaraghavan Madhuravasal Gopalan, Bangalore (IN)

(73) Assignee: NavSemi Energy Private Limited, Singapore (SG)

(21) Appl. No.: 14/276,612

(22) Filed: May 13, 2014

Related U.S. Application Data
(60) Provisional application No. 61/823,152, filed on May 14, 2013.

(51) Int. Cl. H02M 3/156

(52) U.S. Cl. CPC H02M 3/156
USPC 323/282

(57) ABSTRACT

A DC-to-DC power converter includes an input to receive an input voltage and an input current from a solar panel, an output to provide an output voltage and an output current, and a single-stage switched-mode power-conversion circuit, coupled between the input and the output, to convert the input voltage and input current to the output voltage and output current in accordance with a control signal. The DC-to-DC power converter also includes a sense-and-control unit to sense the input voltage, input current, output voltage, and output current, and to generate the control signal based at least in part on one or more of the sensed input voltage, input current, output voltage, and output current.

### RELATED APPLICATIONS

This application claims priority to U.S. Provisional Patent Application No. 61/823,152, titled “Solar Photovoltaic Energy Maximizer with Maximum Power and/or Current Point Tracker for Battery Charging in Off Gird, Smart Grid or Grid Tied Systems,” filed May 14, 2013, which is hereby incorporated by reference in its entirety.

### SUMMARY

A photovoltaic DC-to-DC converter, Maximum Power Point Tracker (MPPT), Maximum Current Point Tracker (MCPT), battery charger, and monitoring and control system are implemented in a single-stage power-conversion circuit design for low-cost, high-reliability performance. The circuit can be used in any combination including but not limited to buck, boost, and buck-and-boost DC-to-DC conversion, with or without a battery charger, MPPT, and/or MPCT.

In some embodiments, a DC-to-DC power converter includes an input to receive an input voltage and an input current from a solar panel, an output to provide an output voltage and an output current, and a single-stage switched-mode power-conversion circuit, coupled between the input and the output, to convert the input voltage and input current to the output voltage and output current in accordance with a control signal. The DC-to-DC power converter also includes a sense-and-control unit to sense the input voltage, input current, output voltage, and output current, and to generate the control signal based at least in part on one or more of the sensed input voltage, input current, output voltage, and output current.

In some embodiments, a method of performing DC-to-DC power conversion includes receiving an input voltage and an input current from a solar panel and performing single-stage switched-mode power-conversion of the input voltage and input current to an output voltage and output current in accordance with a control signal. The method also includes sensing the input voltage, input current, output voltage, and output current, and generating the control signal based at least in part on one or more of the sensed input voltage, input current, output voltage, and output current.

In some embodiments, a non-transitory computer-readable storage medium stores one or more programs configured for execution by a processor in a DC-to-DC power converter that further includes a single-stage switched-mode power-conversion circuit to convert an input voltage and an input current to an output voltage and an output current in accordance with a control signal. The one or more programs include instructions to sense the input voltage, input current, output voltage, and output current, and instructions to generate the control signal based at least in part on one or more of the sensed input voltage, input current, output voltage, and output current.

Embodiments as disclosed herein may be used in off-grid, smart-grid, micro-grid or grid-tied solar-energy systems with or without energy-storage elements. The use of a single-stage power-conversion circuit technique provides low-cost power conversion with high efficiency, high reliability, and long operating life, while avoiding complex circuit designs and expensive components.

### BACKGROUND

Solar photovoltaic (PV) panels (or solar panels for short, and also commonly known as solar modules) are used to convert solar energy into direct current (DC) power. Because solar panels are a limited source of energy, they behave differently than a DC power supply. The output voltage from the PV cells that make up a solar panel varies depending on the current being drawn from the panel. The solar panel power (i.e., the product of panel voltage and panel current) is not constant for all combinations of voltages and currents. There is one operating point where the product of panel voltage and panel current is highest. This point is called the maximum power point (MPP).

The amount of power which can be harvested from solar panels varies in real time as solar panels are exposed to different lighting intensity levels, clouds, or dirt. In addition, solar panels show a tendency to age, which reduces the power-harvesting ability of the panels. The panel performance also depends on operating temperature. These factors cause the MPP to vary over time.

A system or circuit designed to track the MPP in real time is known as an MPP tracker (MPPT) or power-point tracker. In an application in which the output power of a solar panel is used to store energy in a battery or other storage element, once the MPPT locates the MPP, the output should be translated into a voltage level that matches the battery specifications (or storage element specifications). A system or circuit that performs this translation is known as a battery charger. The battery charger ensures that charging requirements of the battery (e.g., as specified in the battery specifications) are met.

The battery nominal voltage requirement can be higher or lower than the MPP voltage of the solar panel (i.e., the output voltage of the solar panel at the MPP) by system design or due to variation of electrical parameters of the solar panel. DC-to-DC conversion is performed to provide the desired charging voltage level for the battery. Buck and/or boost techniques may be used in performing this DC-to-DC conversion.

There is a need for circuits that perform MPP tracking, DC-to-DC conversion, and other functions such as maximum-current-point (MCP) tracking for solar panels in a simple, efficient, low-cost, and reliable manner.

### BRIEF DESCRIPTION OF THE DRAWINGS

The present embodiments are illustrated by way of example and are not intended to be limited by the figures of the accompanying drawings.

FIG. 1A is a circuit diagram of a single-stage switched-mode boost converter circuit.

FIG. 1B is a circuit diagram of the single-stage switched-mode boost converter circuit of FIG. 1A with a sense-and-control block in accordance with some embodiments.

FIG. 1C is a circuit diagram of the single-stage switched-mode boost converter circuit of FIG. 1B with a solar panel connected to the input and a battery or load connected to the output, in accordance with some embodiments.

FIG. 2A is a circuit diagram of a single-stage switched-mode buck converter circuit.

FIG. 2B is a circuit diagram of the single-stage switched-mode buck converter circuit of FIG. 2A with a sense-and-control block in accordance with some embodiments.

FIG. 2C is a circuit diagram of the single-stage switched-mode buck converter circuit of FIG. 2B with a solar panel connected to the input and a battery or load connected to the output, in accordance with some embodiments.

FIGS. 3A-3C are block diagrams showing sense-and-control units that are examples of the sense-and-control blocks of FIGS. 1B-1C and 2B-2C in accordance with some embodiments.

FIG. 4 is a circuit diagram of a boost converter circuit that uses multi-phase clocking in accordance with some embodiments.

FIG. 5A is a timing diagram showing single-phase clocking in accordance with some embodiments.

FIG. 5B is a timing diagram showing multi-phase clocking in accordance with some embodiments.

FIG. 6 is a flowchart of a method of performing DC-to-DC power conversion in accordance with some embodiments.

FIG. 7A is a block diagram showing two circuits, each of which includes a single-stage switched-mode power-converter circuit and its associated sense-and-control unit, with outputs connected in series in accordance with some embodiments.

FIG. 7B is a block diagram showing two circuits, each of which includes a single-stage switched-mode power-converter circuit and its associated sense-and-control unit, with outputs connected in parallel in accordance with some embodiments.

Like reference numerals refer to corresponding parts throughout the figures and specification.

### DETAILED DESCRIPTION

Reference will now be made in detail to various embodiments, examples of which are illustrated in the accompanying drawings. In the following detailed description, numerous specific details are set forth in order to provide a thorough understanding of the disclosure. However, some embodiments may be practiced without these specific details. In other instances, well-known methods, procedures, components, and circuits have not been described in detail so as not to unnecessarily obscure aspects of the embodiments.

A photovoltaic DC-to-DC converter, Maximum-Power-Point Tracker (MPPT), Maximum-Current-Point Tracker (MCPT), battery charger, and/or monitoring and control system are implemented in a single-stage power-conversion circuit design for low-cost, high-reliability performance. Possible configurations for the circuit include but are not limited to buck, boost, and buck-and-boost DC-to-DC conversion, with or without a battery charger, MPPT, and/or MPCT. The circuit can be implemented with or without a use of a custom chip. In some embodiments, the circuit is implemented using standard components such as microcontrollers and power metal-oxide-semiconductor field-effect transistors (MOSFETs) as well as other active and passive components. In some embodiments, the circuit is implemented partially or fully in a monolithic integrated circuit (IC).

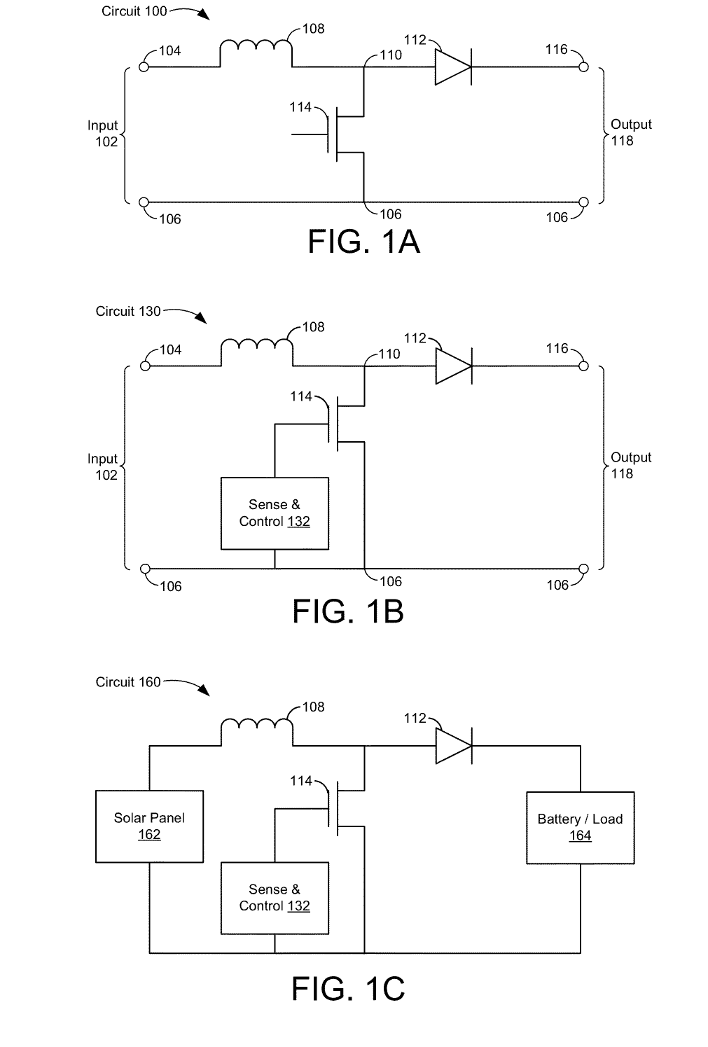

A boost converter (i.e., a step-up converter) is a DC-to-DC power converter with an output voltage greater than its input voltage. Boost converters may be implemented as a class of switched-mode power supply (SMPS) containing at least two semiconductor devices (a diode and a transistor) and at least one energy storage element (e.g., an inductor, capacitor, or the two in combination). FIG. 1A shows a boost converter circuit 100 that includes an inductor 108, transistor (e.g., MOSFET) 114, and diode 112. An input 102 receives an input voltage and input current, and an output 118 provides an output voltage and output current. The inductor 108 is the energy storage element that boosts up the input voltage to a higher level at the output 118. The transistor 114 is a control switch to adjust the flow of energy through the inductor 108. The transistor 114 switches between an ON state and an OFF state based on a control signal applied to its gate. (The boost converter circuit 100 is considered to be a “switched-mode” power supply because of the switching operation of the transistor 114. The term “switched-mode” as used herein is distinct from the term “mode of operation.” Switched-mode power conversion circuitry may operate in multiple modes of operation, as described below.) The diode 112 is a freewheeling diode for energy flow when the transistor 114 is in its OFF state. As a freewheeling diode, the diode 112 prevents the flow of reverse current.

The input 102 includes nodes 104 and 106, while the output 118 includes nodes 116 and 106. The input voltage thus is applied between nodes 104 and 106, while the output voltage is provided between nodes 116 and 106. The inductor 108 and diode 112 are coupled in series between the nodes 104 and 116: the inductor 108 is coupled between the node 104 and an intermediate node 110, while the diode 112 is coupled between the intermediate node 110 and the node 116. The transistor 114 is coupled between the intermediate node 110 and the node 106. The inductor 108, diode 112, and transistor 114 are thereby arranged in a boost configuration, such that the boost converter circuit 100 is a single-stage switched-mode boost converter.

A sense-and-control block 132 may be added to the circuit 100, resulting in a circuit 130 as shown in FIG. 1B in accordance with some embodiments. The sense-and-control block 132 provides a control signal (i.e., a gate signal) to the gate of the transistor 114. The control signal may be a clock signal with a duty cycle that is determined by the sense-and-control block 132. In one example, the clock signal has a period of approximately 10 microseconds (us). Duty cycle is the fraction (e.g., percentage) of a period in which the clock cycle is asserted (e.g., in a logic-high state), as opposed to de-asserted (e.g., in a logic-low state).

A solar panel 162 may be connected to the input 102 of the circuit 130 and a battery or load 164 may be connected to the output 118 of the circuit 130, resulting in the circuit 160 of FIG. 1C in accordance with some embodiments. The circuit 130 (e.g., with discrete components as shown in FIG. 1B) thus may act as a solar photovoltaic battery charger. The charger will ensure, for example, that a battery 164 is receiving a maximum amount of allowed charge without violating battery specifications such as over voltage, charging current limit, bulk charging, boost charging and float charging.

The sense-and-control block 132 senses the panel and battery conditions and relatively adjusts the duty cycle of the gate signal. In some embodiments, maximum-power-point tracking is performed (e.g., in an MPPT mode of operation): the sense-and-control block 132 senses the voltage and current of the solar panel 162 (i.e., the input voltage and input current that the solar panel 162 provides to the input 102) while varying the duty cycle of the gate signal provided to the transistor 114. The duty cycle that maximizes the product of input voltage and input current is then set as the duty cycle of the gate signal, to extract maximum power from the solar panel 162. The same phenomenon serves the purpose of impedance matching to facilitate maximum power transfer from the photovoltaic source (i.e., the solar panel 162) to the battery/load 164.

In some embodiments, maximum-current-point tracking is performed (e.g., in an MCPT mode of operation): the sense-and-control block 132 senses the current feed into the battery/load 164 (i.e., the output current that the battery/load 164 receives from the output 118) while varying the duty cycle of the gate signal provided to the transistor 114. The duty cycle that maximizes the output current is then set as the duty cycle of the gate signal.

The sense-and-control block 132 also takes appropriate action based on output-side voltage and current (i.e., the output voltage and output current at the output 118). In some embodiments, if the output voltage and/or output current fail to satisfy respective criteria (e.g., are outside of preset limits), the sense-and-control block 132 disables (e.g., de-asserts) the gate signal provided to the transistor 114, thereby putting the circuit 130 in standby (e.g., in an idle mode). For example, if a battery 164 is present at the output 118, then the output current is the charging current of the battery 164. If the sense-and-control block 132 determines that output voltage or charging current is outside of a preset limit associated with the battery 164, it disables the gate signal, thereby putting the circuit 130 in standby.

In some embodiments, in the absence of a battery 164 and presence of a direct load 164 on the output 118, the sense-and-control block 132 detects the absence of the battery and, in response, regulates a preset voltage at the output 118. The maximum power transfer hence takes place with the output voltage being regulated within preset thresholds and the output current being varied based on extracted power. The sense-and-control block 132 may detect the absence of the battery, for example, by determining that, upon activation of the system, a rate of change of the output voltage satisfies a threshold (e.g., exceeds the threshold, or equals or exceeds the threshold). Alternatively, the sense-and-control block 132 may detect the absence of the battery by determining that a difference between the input voltage and output voltage upon system activation satisfies (e.g., is greater than, or greater than or equal to) a threshold or by determining that the value of the output voltage upon system activation does not satisfy (e.g., is less than, or less than or equal to) a threshold.

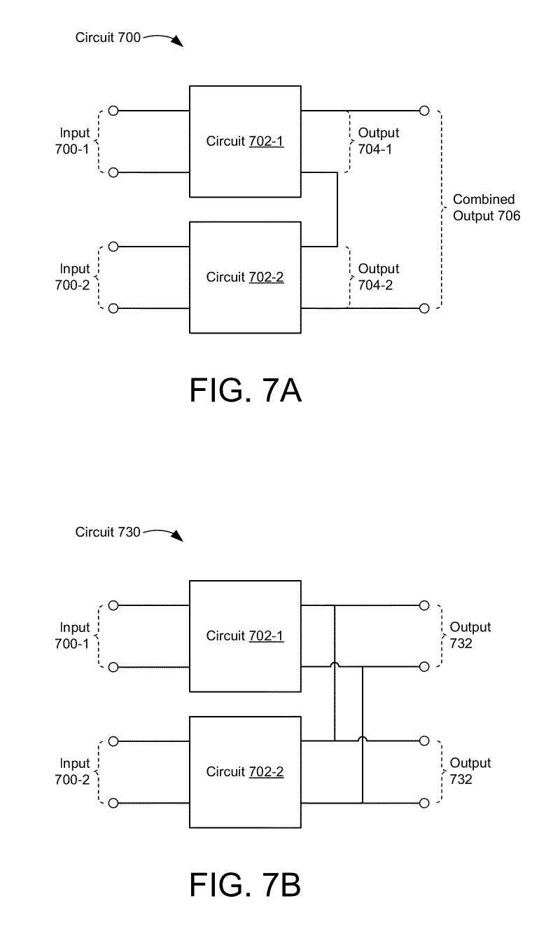

The architecture of FIG. 1B self-adapts to parallel and/or series connection of multiple units at the output side where the diode 112 provides a forward path only (i.e., a current path that only flows in a forward direction) from the corresponding solar panel 162 connected to the input of the unit. This facilitates series/parallel operation and limitless scaling of the capacity of the system in use. Multiple instances of the circuit 130 thus may be connected in series and/or in parallel (i.e., with their outputs connected in series and/or in parallel) between respective solar panels 162 and a battery or load 164 (e.g., as described below with respect to FIGS. 7A and 7B).

A buck converter (i.e., a step-down converter) is a DC-to-DC power converter with an output voltage less than its input voltage. A buck converter thus will step down the voltage from a solar panel to a lower desired voltage level. Similar to the boost converter, a buck converter may be implemented as a class of switched-mode power supply (SMPS) and may include a semiconductor switch (e.g., transistor), a diode, and other passive components.

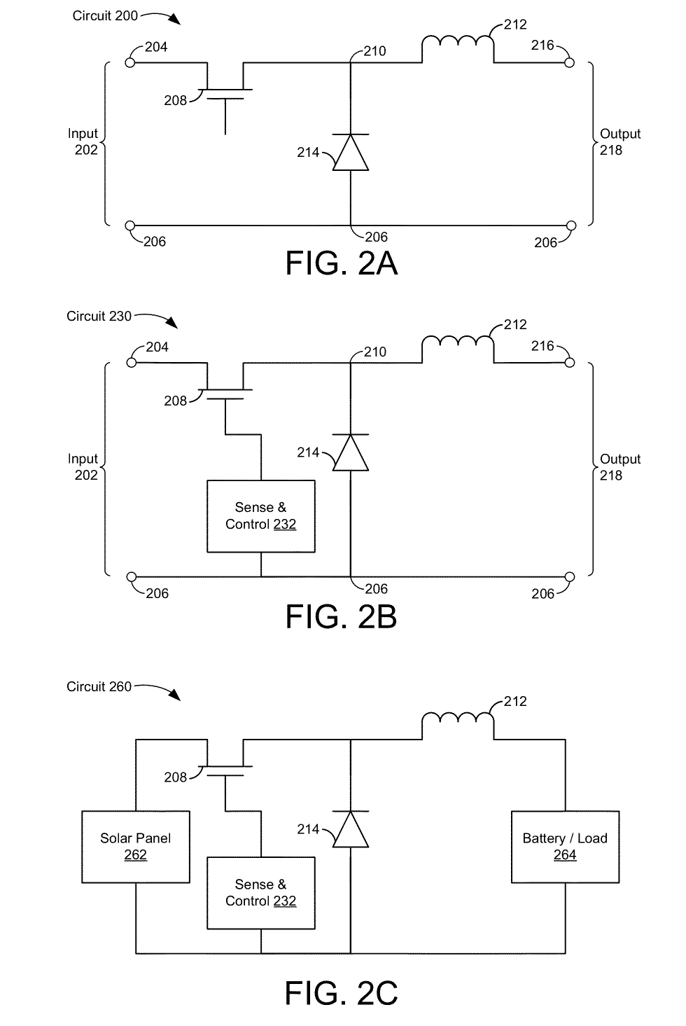

FIGS. 2A-2C show the elements of a buck converter and its application as a single-stage MPP/MCP battery charger. FIG. 2A shows a buck converter circuit 200 that includes a transistor (e.g., MOSFET) 208, an inductor 212, and a diode 214. An input 202 receives an input voltage and input current, and an output 218 provides an output voltage and output current. The transistor 208 is a control switch to adjust the flow of energy through the inductor 212. The transistor 208 switches between an ON state and an OFF state based on a control signal applied to its gate. The duty cycle of the transistor 208, and thus of the control signal applied to its gate, determines the factor by which the input voltage is stepped down, such that the output voltage equals the input voltage times the duty cycle. (The buck converter circuit 200 is considered to be a “switched-mode” power supply because of the switching operation of the transistor 208. Again, the term “switched-mode” is independent of the “mode of operation.”)

The input 202 includes nodes 204 and 206, while the output 218 includes nodes 216 and 206. The input voltage thus is applied between nodes 204 and 206, while the output voltage is provided between nodes 216 and 206. The transistor 208 and inductor 212 are coupled in series between the nodes 204 and 216: the transistor 208 is coupled between the node 204 and an intermediate node 210, while the inductor 212 is coupled between the intermediate node 210 and the node 216. The diode 214 is coupled between the node 206 and the intermediate node 210. The transistor 208, inductor 212, and diode 214 are thereby arranged in a buck configuration, such that the buck converter circuit 200 is a single-stage switched-mode buck converter.

A sense-and-control block 232 may be added to the circuit 200, resulting in a circuit 230 as shown in FIG. 2B in accordance with some embodiments. The sense-and-control block 232 provides a control signal (i.e., a gate signal) to the gate of the transistor 208, in the manner described for the sense-and-control block 132 (FIGS. 1B-1C). A solar panel 262 may be connected to the input 202 of the circuit 230 and a battery or load 264 may be connected to the output 218 of the circuit 230, resulting in the circuit 260 of FIG. 2C in accordance with some embodiments. The circuit 230 (e.g., with discrete components as shown in FIG. 2B) thus may act as a solar photovoltaic battery charger. The charger will ensure, for example, that a battery 164 is receiving a maximum amount of allowed charge without violating battery specifications such as over voltage, under voltage, charging current limit, bulk charging, boost charging and float charging.

The sense-and-control block 232 senses the panel and battery conditions and relatively adjusts the duty cycle of the gate signal, in an analogous manner to the sense-and-control block 132 (FIGS. 1B-1C). In some embodiments, maximum-power-point tracking and/or maximum-current-point tracking are performed (e.g., in respective MPPT and/or MCPT modes of operation). The sense-and-control block 132 may also take appropriate action based on output-side voltage and current (i.e., the output voltage and output current at the output 218), in an analogous manner as the sense-and-control block 132 (FIGS. 1B-1C). In some embodiments, the sense-and-control block 232 may detect the absence of a battery 264 and, in response, regulate a preset voltage at the output 218, such that the output voltage remains within present limits about the preset voltage.

Simple rearrangement of the components used in the step-up design (boost converter) of FIGS. 1A-1C thus yields a step-down converter for applications with an output voltage less than the input solar photovoltaic potential (i.e., the input voltage provided by the solar panel 262). Also, in some embodiments the functionality of the diodes 112 and/or 214 may be implemented using transistors (e.g., MOSFETs). (Furthermore, it should be noted that the circuit symbol for transistors may or may not include a body diode. The presence or absence of a body diode in the transistor symbols in the drawings should not be interpreted as having any structural implication.) The sense-and-control block 232 remains the same as the sense-and-control block 132, in that it senses the input and output voltages and currents to control the duty cycle of the gate signal for tracking and regulation purposes.

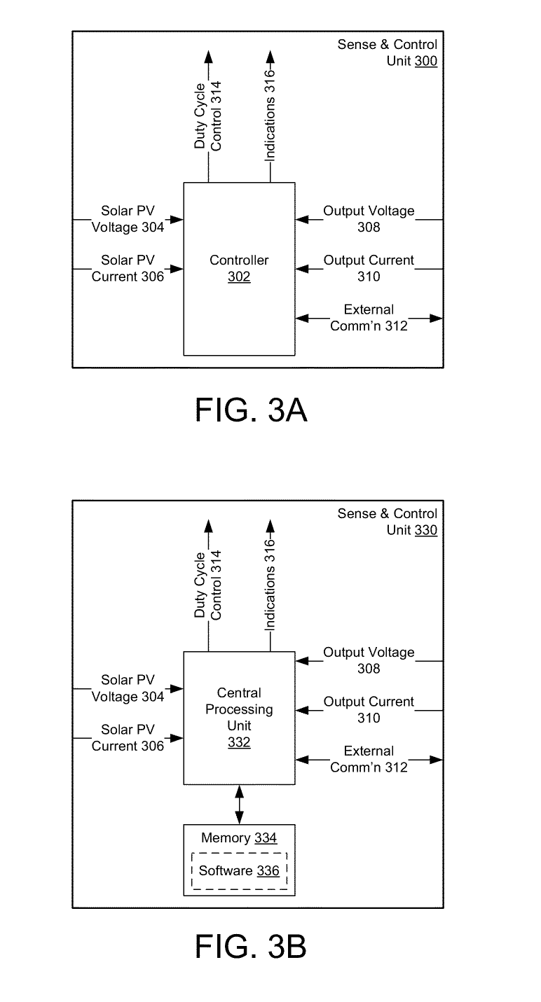

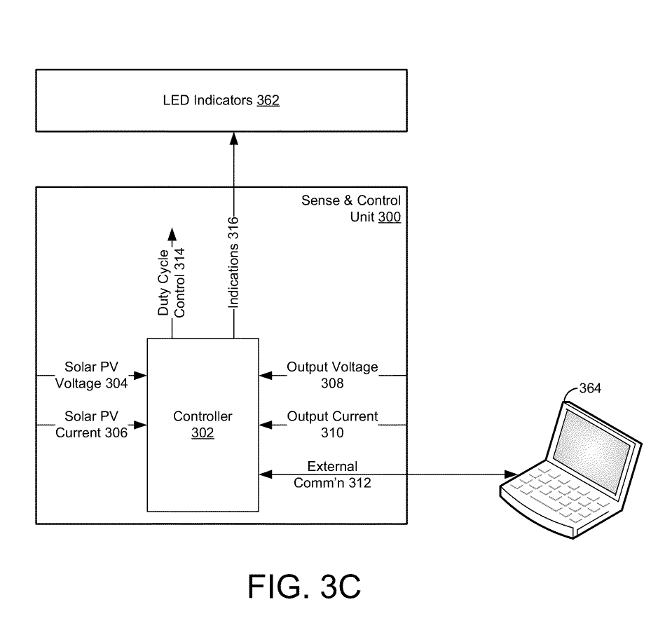

FIG. 3A is a block diagram showing a sense-and-control unit 300 in accordance with some embodiments. The sense-and-control unit 300 is an example of a sense-and-control block 132 (FIG. 1B-1C) or 232 (FIGS. 2B-2C) in accordance with some embodiments. The sense-and-control unit 300 includes a controller 302 that senses the solar PV voltage 304 (e.g., the input voltage at an input 102 or 202), solar PV current 306 (e.g., the input current at an input 102 or 202), output voltage 308 (e.g., at an output 118 or 218), and output current 310 (e.g., at an output 118 or 218). (These sense inputs to the sense-and-control unit 300 are not shown for the sense-and-control blocks 132 and 232 in FIGS. 1B-1C and 2B-2C, for visual simplicity.) The controller 302 generates a duty-cycle-control signal 314, based on which a gate signal having a duty cycle specified by the duty-cycle-control signal 314 is generated and provided to a switch (e.g., the transistor 114 or 208) in a single-stage switched-mode power-conversion circuit. For example, the duty-cycle-control signal 314 is provided to a clock (not shown) in the sense-and-control unit 300. The clock generates a gate signal in accordance with the duty-cycle-control signal 314. Alternatively, the controller 302 itself generates the gate signal, in which case the duty-cycle-control signal 314 is an internal signal in the controller 302. The duty-cycle-control signal 314 is generated based, at least in part, on one or more of the sensed solar PV voltage 304, solar PV current 306, output voltage 308, and output current 310.

In some embodiments, the controller 302 includes an interface to connect to a bus 312 for external communications with an external monitoring system 364 (FIG. 3C). (The bus 312 is not shown for the sense-and-control blocks 132 and 232 in FIGS. 1B-1C and 2B-2C, for visual simplicity.) The controller 302 may report its status to the external monitoring system 364. The external monitoring system 364 may send commands to the controller 302. For example, the external monitoring system 364 may specify a mode of operation (e.g., MPPT mode or MPCT mode) for the controller 302, and thereby for the sense-and-control unit 300 and the corresponding power conversion circuit in which the sense-and-control unit 300 is situated. The duty-cycle-control signal 314 thus may be generated based at least in part on the specified mode.

Alternatively, the duty-cycle-control signal 314 may be generated based at least in part on a mode of operation selected by the sense-and-control unit 300 (e.g., based on one or more of the sensed solar PV voltage 304, solar PV current 306, output voltage 308, and output current 310). Examples of such modes include but are not limited to MPPT mode, MCPT mode, voltage-control mode, float mode, absorption mode, and standby mode. In voltage-control mode, a battery (e.g., battery 164 or 264) at the output (e.g., output 118 or 218) is fully charged and the sense-and-control unit 300 tracks the voltage at the output. In float mode, a battery (e.g., battery 164 or 264) at the output (e.g., output 118 or 218) is floating and the power converter provides a trickle of power to the battery. The trickle of power is a specified amount of power that is less than the power provided when charging the battery. In absorption mode the power converter provides power to excite the battery (e.g., battery 164 or 264). A constant output voltage is provided while the output current gradually decreases as the battery charges. In standby mode, which is also referred to as idle mode, the power converter is idle (e.g., in response to the absence of a battery at the output). (In some embodiments, any or all of these modes may also be specified by the external monitoring system 364.)

In some embodiments, the controller 302 generates one or more indication signals 316 that indicate the mode in which the controller 302 is operating. (The indication signals 316 are not shown for the sense-and-control blocks 132 and 232 in FIGS. 1B-1C and 2B-2C, for visual simplicity.) The indication signals 316 may be provided to LED indicators 362 or another suitable user interface for displaying an indication of the mode of operation.

In some embodiments, the controller 302 is a processor, such as a central processing unit (CPU) 332, as shown in FIG. 3B in accordance with some embodiments. In one example, the CPU 332 is an 8-bit microcontroller. The CPU 332 is coupled to a memory 334. The memory 334 includes non-volatile memory that serves as a non-transitory computer-readable storage medium to store software 336 for execution by the CPU 332. The software 336 includes one or more programs with instructions that, when executed by the CPU 332, cause the CPU 332 to implement the functionality of the sense-and-control unit 300 as described herein. For example, the software 336 includes instructions to sense the solar PV voltage 304, solar PV current 306, output voltage 308, and output current 310; to generate the duty-cycle-control signal 314; to determine a mode of operation; to send status reports to the external monitoring system 364; to perform commands received from the external monitoring system 364; and/or to transmit indication signals 316.

Other examples of types of circuits that may be used to implement the controller 302 include but are not limited to field-programmable gate arrays (FPGAs), discrete logic, and custom integrated circuits.

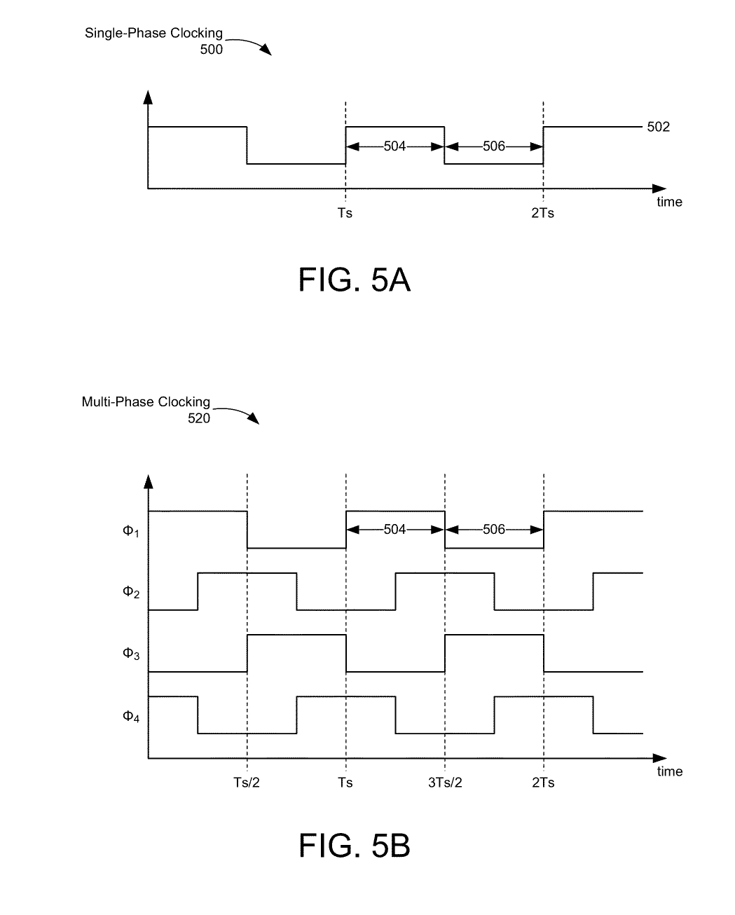

Attention is now directed to different clocking schemes. In the examples of FIGS. 1A-1C and 2A-2C, single-phase clocking is used: a single clock signal with a single associated phase is provided as the gate signal/control signal to the transistor 114 (FIGS. 1A-1C) or the transistor 208 (FIGS. 2A-2C). FIG. 5A is a timing diagram showing single-phase clocking 500 in accordance with some embodiments. A single clock signal 502 has a period Ts. Within each period, the clock signal 502 has an on time 504 during which it is asserted and an off time 506 during which it is de-asserted. The on time 504 (and corresponding off time 506) may be varied (e.g., while holding the period constant), thereby varying the duty cycle. For example, the duty-cycle-control signal 314 (FIGS. 3A-3C) may specify the on time 504 (or equivalently, the off time 506).

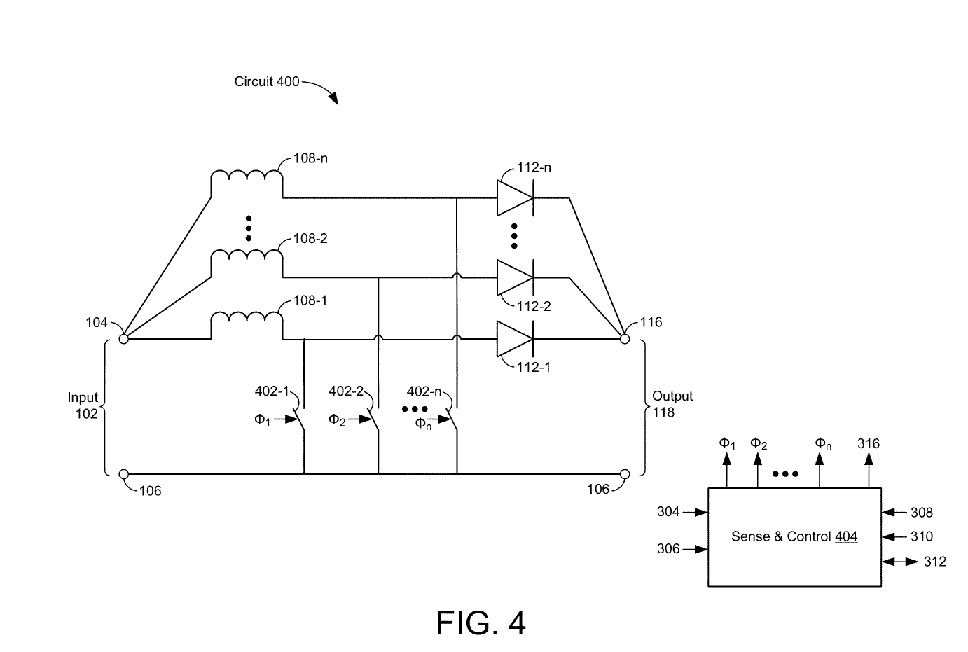

In some embodiments, multi-phased clocking is used instead of single-phased clocking. FIG. 4 is a circuit diagram of a boost converter circuit 400 that uses multi-phase clocking in accordance with some embodiments. The boost converter circuit 400 includes a single-stage switched-mode power conversion circuit with a plurality of inductors 108-1 through 108-n, a plurality of switches (e.g., transistors, for example MOSFETs) 402-1 through 402-n, and a plurality of diodes 112-1 through 112-n, where n is an integer greater than one. Examples of values of n include two, or three, or four or more. Respective groups of inductors 108, switches 402, and diodes 112 are arranged in parallel in boost configurations. For example, the inductor 108-1, switch 402-1, and diode 112-1 are arranged in a first boost configuration; the inductor 108-2, switch 402-2, and diode 112-2 are arranged in a second boost configuration; and the inductor 108-n, switch 402-n, and diode 112-n are arranged in a third boost configuration, with the first, second, and third boost configurations situated in parallel.

A sense-and-control block 404, which is an example of a sense-and-control unit 300 (FIG. 3A) (e.g., a sense-and-control unit 330, FIG. 3B), generates a plurality of clock signals φ₁ through φₙ, which are provided as control signals (e.g., as gate signals) to respective switches 402-1 through 402-n. The clock signals φ₁ through φₙ are phase-shifted with respect to each other. For example, the sense-and-control block 404 includes a phase clock that generates the clock signals φ₁ through φₙ in accordance with a duty-cycle-control signal 314. In some embodiments, the clock signals φ₁ through φₙ all have the same duty cycle. Alternatively, the duty cycles of the clock signals φ₁ through φₙ may differ.

FIG. 5B is a timing diagram showing multi-phase clocking 520 in accordance with some embodiments. In the example of FIG. 5B, n=4, such that there are four clock signals φ₁ through φ₄, which are phase-shifted with respect to each other (e.g., by a phase of π/2). Each of the four clock signals φ₁ through φ₄ has an on time 504 during which it is asserted and an off time 506 during which it is de-asserted. The on time 504 (and corresponding off time 506) may be varied (e.g., while holding the period constant), thereby varying the duty cycle of the clock signals φ₁ through φ₄. For example, the duty-cycle-control signal 314 (FIGS. 3A-3C) may specify the on time 504 (or equivalently, the off time 506).

While FIG. 4 shows a boost converter circuit 400 that uses multi-phase clocking, a buck converter circuit may also use multi-phase clocking in accordance with some embodiments. For example, a buck converter circuit may include a single-stage switched-mode power conversion circuit with a plurality of inductors, a plurality of switches (e.g., transistors, for example MOSFETs), and a plurality of diodes. Respective groups of inductors, switches, and diodes are arranged in parallel in buck configurations, with each group arranged as shown in FIGS. 2A-2C. The switches are clocked as described for FIG. 4 (e.g., using the multi-phase clocking 520, FIG. 5B).

The use of multi-phased clocking reduces the thermal stress on individual components of a power converter and allows the size of individual components to be reduced, thus facilitating integration of the power converter into the junction box of a solar panel. The use of multi-phased clocking also helps to reduce electromagnetic emissions (e.g., electromagnetic interference) from the power converter.

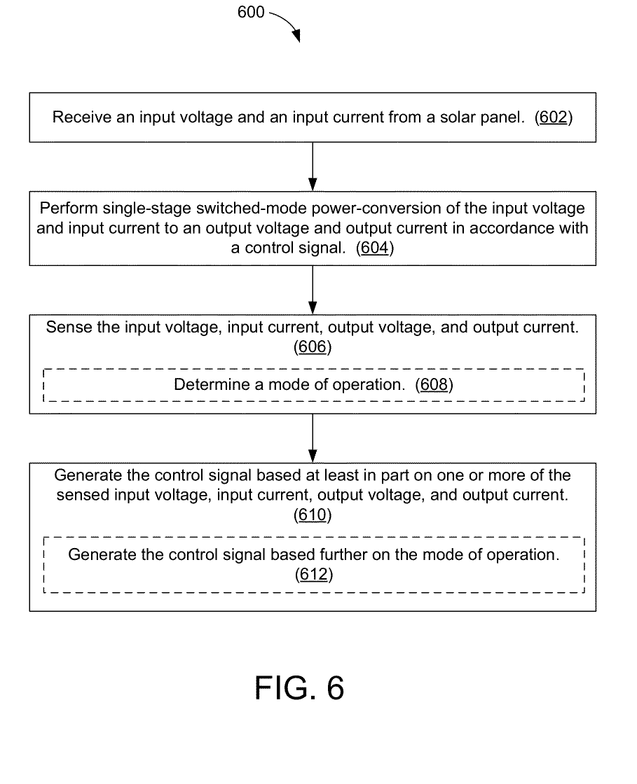

FIG. 6 is a flowchart of a method 600 of performing DC-to-DC power conversion in accordance with some embodiments. The method 600 is performed, for example, in the circuit 160 (FIG. 1C), the circuit 260 (FIG. 2C), the circuit 400 (FIG. 4), or similar circuits.

In the method 600, an input voltage and an input current are received (602) from a solar panel (e.g., a solar panel 162 or 262). Single-stage switched-mode power-conversion of the input voltage and input current to an output voltage and output current is performed (604) in accordance with a control signal. The input voltage, input current, output voltage, and output current are sensed (606) (e.g., by a sense-and-control unit 300, FIG. 3A). In some embodiments, a mode of operation is determined (608). The mode is determined, for example, based on one or more of the sensed parameters, or based on a command from an external monitoring system. The control signal is generated (610) based at least in part on one or more of the sensed input voltage, input current, output voltage, and output current. In some embodiments, the control signal is generated (612) based further on the mode of operation.

While the method 600 includes a number of operations that appear to occur in a specific order, it should be apparent that the method 600 can include more or fewer operations, two or more operations may be combined into a single operation, and performance of two or more operations may overlap. For example, the operations 602, 604, 606, and 610 may be performed simultaneously in an ongoing manner (e.g., using the multi-threading, multi-tasking, and/or pipelining capabilities of the CPU 332, FIG. 3B).

Examples of domains in which embodiments as disclosed herein may find use include, but are not limited to:
Wireless mobile-phone-data-transceiver towers that use 48V DC batteries for operation. Wide-spread installations are well served with point-of-load, renewable solar photovoltaic sources and 48V battery-powered systems.
Rural banking and residential applications where grid power is not available or reliable and the major sources of power are non-renewable sources such as diesel generators.
Oceanic (water submerged) PV installations and locomotives are attractive targets, due to the simplicity, ruggedness, and scalability of some embodiments.

Devices as disclosed herein (e.g., the disclosed single-stage power-conversion circuits and their corresponding sense-and-control units) can be connected (i.e., have their outputs connected) in series, in parallel, or in a series/parallel combination to create systems to charge any sized batteries (e.g., to provide voltage as well as charging currents that are compatible for batteries of arbitrary sizes.) In some embodiments, the outputs of these devices can be connected in series, in parallel, or in a series/parallel combination to create systems to charge any type of battery using different software algorithms (e.g., as included in the software 336, FIG. 3B) to program the respective conditions to meet the battery specifications (e.g., for lead acid batteries, lithium ion batteries, fuel cells, etc.). In some embodiments, the outputs of these devices can be connected in series, in parallel, or in a series/parallel combination to create systems without battery storage. In this case these devices will act as power maximizers ensuring every panels is operating at MPP in all given operating conditions.

FIG. 7A is a block diagram showing a circuit 700 that includes two circuits 702-1 and 702-2 with outputs connected in series in accordance with some embodiments. Each of the circuits 702-1 and 702-2 includes a single-stage switched-mode power-converter circuit and its associated sense-and-control unit. For example, each of the circuits 702-1 and 702-2 may be a circuit 130 (FIG. 1 B), a circuit 230 (FIG. 2B), a circuit 400 (FIG. 4B), or a multiphase buck converter and associated sense-and-control unit. The circuit 702-1 has an input 700-1, which connects to a first solar panel, and an output 704-1. The circuit 702-2 has an input 700-2, which connects to a second solar panel, and an output 704-2. The outputs 704-1 and 704-2 are connected in series as shown, resulting in a combined output 706 with an output voltage equal to the sum of the output voltages for the outputs 704-1 and 704-2.

FIG. 7B is a block diagram showing a circuit 730 in which the outputs of the circuits 702-1 and 702-2 are connected in parallel in accordance with some embodiments. The circuits 702-1 and 702-2 thus share a single output 732, such that the output voltage of the circuit 702-1 equals the output voltage of the circuit 702-2.

Embodiments as disclosed herein may be used in off-grid, smart-grid, micro-grid or grid-tied solar-energy systems with or without energy-storage elements. Disclosed systems may be upgraded in the future by adding storage, expanding storage capacity, adding solar capacity, and more. The use of a single-stage power-conversion circuit technique using single-phase or multi-phase clocking schemes enables implementations to have low cost, high efficiency, high reliability, and long operating life. Furthermore, by achieving desired functionality in a single-stage power-conversion circuit, embodiments as disclosed herein avoid complex, expensive circuit design or expensive components.

Examples of embodiments that may be implemented as disclosed herein are now reviewed.

A method thus may be performed of implementing a battery charger in a single circuit design stage to achieve multiple-stage functionality of a DC-to-DC converter (buck or boost or both), MPP tracker, MCP tracker, and power optimizer.

A method thus may be performed of implementing a solar-power optimizer in a single circuit design stage to achieve multiple-stage functionality of a DC-to-DC converter (buck or boost or both), MPP tracker, MCP tracker, and power optimizer.

A single-stage-circuit-design approach thus achieves multiple-stage functionality of DC-to-DC conversion (buck or boost or both), MPP tracking, MCP tracking and battery charging in a single power-conversion stage that handles full power using a single phase, two phases, three phases, four phases, or in theory any number of clock phases practical for cost-effective design implementation.

A method thus may be performed of implementing a circuit design that boosts and/or bucks the output voltage of solar panels to desired voltage levels for energy-storage elements such as batteries or for driving various types of loads such as inverters or DC loads.

A method may be performed of achieving MPP tracking in photovoltaic systems while ensuring that the maximum energy output available from solar panels is transferred to batteries and/or to a load optimally.

A method may be performed or a system may be implemented utilizing products based on disclosed embodiments to create scalable, flexible, expandable, and upgradable off-grid, micro-grid, smart-grid or grid-tied solar systems or solar-hybrid systems

An algorithm for tracking the MPP in a solar system using a single-stage power-conversion circuit may be implemented as described herein.

A circuit design for a DC-to-DC power converter (buck, boost, or both) may be used in a single-stage multi-function power converter as disclosed herein.

The foregoing description, for purpose of explanation, has been described with reference to specific embodiments. However, the illustrative discussions above are not intended to be exhaustive or to limit all embodiments to the precise forms disclosed. Many modifications and variations are possible in view of the above teachings. The disclosed embodiments were chosen and described to best explain the underlying principles and their practical applications, to thereby enable others skilled in the art to best implement various embodiments with various modifications as are suited to the particular use contemplated.

What is claimed is:

1. A DC-to-DC power converter, comprising:
an input to receive an input voltage and an input current from a solar panel;
an output to provide an output voltage and an output current;
a single-stage switched-mode power-conversion circuit, coupled between the input and the output, to convert the input voltage and input current to the output voltage and output current in accordance with a control signal; and
a sense-and-control unit to sense the input voltage, input current, output voltage, and output current, and to generate the control signal based at least in part on one or more of the sensed input voltage, input current, output voltage, and output current.

2. The DC-to-DC power converter of claim 1, wherein the sense-and-control unit is to generate the control signal based further on battery specifications for a battery to be connected to the output.

3. The DC-to-DC power converter of claim 2, wherein the sense-and-control unit is to generate the control signal based further on the battery specifications in response to detecting that the battery is present at the output.

4. The DC-to-DC power converter of claim 1, wherein:
the sense-and-control unit comprises an interface to communicate with an external monitoring system; and
the sense-and-control unit is to generate the control signal based further on a command received through the interface from the external monitoring system, the command specifying a mode of operation.

5. The DC-to-DC power converter of claim 1, wherein:
the single-stage switched-mode power-conversion circuit comprises an inductor, a diode, and a switch configured in either a buck or boost configuration; and
the sense-and-control unit is coupled to the switch to provide the control signal to the switch to control operation of the switch.

6. The DC-to-DC power converter of claim 5, wherein:
the control signal comprises a clock signal; and
the sense-and-control unit is to set a duty cycle of the clock signal based at least in part on one or more of the sensed input voltage, input current, output voltage, and output current.

7. The DC-to-DC power converter of claim 6, wherein the sense-and-control unit is configurable in a maximum-power-point-tracking mode to vary the duty cycle of the clock signal to identity and track a maximum-power point for the input voltage and input current.

8. The DC-to-DC power converter of claim 6, wherein the sense-and-control unit is configurable in a maximum-current-point-tracking mode to vary the duty cycle of the clock signal to identity and track a maximum-current point for the output current.

9. The DC-to-DC power converter of claim 6, wherein the sense-and-control unit is to adjust the duty cycle of the clock signal to cause the single-stage switched-mode power-conversion circuit to regulate the output voltage at a specified voltage level, in response to detecting the absence of a battery at the output.

10. The DC-to-DC power converter of claim 6, wherein the sense-and-control unit is configurable in a voltage-control mode to adjust the duty cycle of the clock signal to cause the single-stage switched-mode power-conversion circuit to provide the output voltage at a specified voltage level.

11. The DC-to-DC power converter of claim 6, wherein the sense-and-control unit is to adjust the duty cycle of the clock signal to cause the single-stage switched-mode power-conversion circuit to provide a specified trickle of power in response to a determination that a battery at the output is floating.

12. The DC-to-DC power converter of claim 5, wherein the sense-and-control unit is to detect whether at least one of the output current and output voltage does not satisfy a respective criterion and, in response to detecting that at least one of the output current and output voltage does not satisfy the respective criterion, to disable the control signal to place the single-stage switched-mode power-conversion circuit in an idle mode.

13. The DC-to-DC power converter of claim 5, wherein:
the input comprises a first node and a second node;
the output comprises a third node and a second node;
the inductor and the diode are coupled in series between the first node and the third node, with the inductor situated between the first node and a fourth node and the diode situated between the fourth node and the third node; and
the switch is coupled between the fourth node and the second node;
whereby the inductor, the diode, and the switch are configured in a boost configuration.

14. The DC-to-DC power converter of claim 5, wherein:
the input comprises a first node and a second node;
the output comprises a third node and a second node;
the switch and the inductor are coupled in series between the first node and the third node, with the switch situated between the first node and a fourth node and the inductor situated between the fourth node and the third node; and
the diode is coupled between the second node and the fourth node;
whereby the inductor, the diode, and the switch are configured in a buck configuration.

15. The DC-to-DC power converter of claim 5, wherein:
the inductor is a first inductor, the diode is a first diode, the switch is a first switch, and the control signal is a first clock signal;
the single-stage switched-mode power-conversion circuit comprises a plurality of inductors including the first inductor, a plurality of diodes including the first diode, and a plurality of switches including the first switch;
respective inductors of the plurality of inductors are coupled to respective diodes of the plurality of diodes and respective switches of the plurality of switches in respective buck or boost configurations;
the sense-and-control unit is to generate multiple clock signals, including the first clock signal, that are phase-shifted with respect to each other, and to provide respective clock signals of the multiple clock signals to respective switches of the plurality of switches; and
the sense-and-control unit is to set a duty cycle for the multiple clock signals based at least in part on one or more of the sensed input voltage, input current, output voltage, and output current.

16. The DC-to-DC power converter of claim 1, wherein the sense-and-control unit comprises:
a processor; and
memory storing instructions that, when executed by the processor, cause the sense-and-control unit to generate the control signal based at least in part on one or more of the sensed input voltage, input current, output voltage, and output current.

17. The DC-to-DC power converter of claim 1, wherein the input, input voltage, input current, output, output voltage, output current, single-stage switched-mode power-conversion circuit, sense-and-control unit, control signal, and solar panel are respectively a first input, first input voltage, first input current, first output, first output voltage, first output current, first single-stage switched-mode power-conversion circuit, first sense-and-control unit, first control signal, and first solar panel, the DC-to-DC power converter further comprising:
a second input to receive a second input voltage and a second input current from a second solar panel;
a second output to provide a second output voltage and a second output current;
a second single-stage switched-mode power-conversion circuit, coupled between the second input and the second output, to convert the second input voltage and second input current to the second output voltage and second output current in accordance with a second control signal; and
a second sense-and-control unit to sense the second input voltage, second input current, second output voltage, and second output current, and to generate the second control signal based at least in part on one or more of the sensed second input voltage, second input current, second output voltage, and second output current;
wherein the first output and the second output are connected in series to provide a total output voltage equal to a sum of the first output voltage and the second output voltage.

18. The DC-to-DC power converter of claim 1, wherein the input, input voltage, input current, output, output voltage, output current, single-stage switched-mode power-conversion circuit, sense-and-control unit, control signal, and solar panel are respectively a first input, first input voltage, first input current, first output, first output voltage, first output current, first single-stage switched-mode power-conversion circuit, first sense-and-control unit, first control signal, and first solar panel, the DC-to-DC power converter further comprising:
a second input to receive a second input voltage and a second input current from a second solar panel;
a second output to provide a second output voltage and a second output current;
a second single-stage switched-mode power-conversion circuit, coupled between the second input and the second output, to convert the second input voltage and second input current to the second output voltage and second output current in accordance with a second control signal; and
a second sense-and-control unit to sense the second input voltage, second input current, second output voltage, and second output current, and to generate the second control signal based at least in part on one or more of the sensed second input voltage, second input current, second output voltage, and second output current;
wherein the first output and the second output are connected in parallel, whereby the first output voltage equals the second output voltage.

19. A method of performing DC-to-DC power conversion, comprising:
receiving an input voltage and an input current from a solar panel;
performing single-stage switched-mode power-conversion of the input voltage and input current to an output voltage and output current in accordance with a control signal;
sensing the input voltage, input current, output voltage, and output current; and
generating the control signal based at least in part on one or more of the sensed input voltage, input current, output voltage, and output current.

20. A non-transitory computer-readable storage medium storing one or more programs configured for execution by a processor in a DC-to-DC power converter that further comprises a single-stage switched-mode power-conversion circuit to convert an input voltage and an input current to an output voltage and an output current in accordance with a control signal, the one or more programs comprising:
instructions to sense the input voltage, input current, output voltage, and output current; and
instructions to generate the control signal based at least in part on one or more of the sensed input voltage, input current, output voltage, and output current.
